(19) United States
(12) Patent Application Publication
(10) Pub. No.: US 2007/0055743 A1
(43) Pub. Date: Mar. 8, 2007

(54) REMOTE CONTROL MEDIA PLAYER

(76) Inventors: Ross Murray Pirtle, Kings Park, NY (US); Thomas Albert DiEmidio, Bohemia, NY (US); George Hallett Denton, Mt. Tremper, NY (US)

Correspondence Address: STEPTOE & JOHNSON LLP, 1330 CONNECTICUT AVENUE, N.W., WASHINGTON, DC, 20036, US

(21) Appl. No.: 11/425,655

(22) Filed: Jun. 21, 2006

Related U.S. Application Data
(60) Provisional application No. 60/714,146, filed on Sep. 2, 2005.

(51) Int. Cl. G06F 15/16

(52) U.S. Cl. 709/217

(57) ABSTRACT

Systems and methods for transferring data to a remote player device include establishing a two-way direct connection between a personal media server and the remote player device. A remote device includes a processor and memory storing computer readable instructions that, when executed by the processor, cause the remote device to perform steps of: establishing a two-way direct connection between a personal media server storing media thereon and the remote device; initiating data transfer requests associated with the media from the remote device directly to the personal media server; and sending the media from the personal media server to the remote device.

### CROSS-REFERENCE To RELATED APPLICATION

This application claims the benefit of Provisional Application No. 60/714,146 filed Sep. 2, 2005 under 35 U.S.C. § 119(e) and entitled “System and Method for Transferring Data to a Remote Player Device,” and the entire contents of this provisional application are expressly incorporated herein by reference thereto.

### FIELD OF THE INVENTION

The present invention relates generally to data transfer. More particularly, the present invention relates to systems and methods for transferring data to a remote player device. In addition, the present invention relates to systems and methods for establishing a two-way direct connection.

### BACKGROUND OF THE INVENTION

Remote player devices, such as cellular telephones, personal digital assistants (“PDAs”), MP3 players, and the like, are capable of playing music files (as well as other media in many instances), allowing users to listen to their choice of music wherever they go. In order to comply with copyright laws, users typically pay for a music or video file and then can download it to a computer (e.g., desktop computer). After downloading the music file to a computer, users can, if authorized, transfer the file to a portable computing device.

However, the popularity of music downloads has grown to a point where a user may download more music files than can fit on, for example, their PDA, cellular telephone, or other remote player device. Conventional file systems designed for storage and retrieval of data are not well suited for the transfer of data to the smaller storage capacities of remote player devices.

The widespread application of Digital Rights Management (DRM) to provide not only security and encryption to avoid unauthorized copying, but also to govern the description, identification, trading, protection, monitoring, and tracking of the various rights and the concomitant management of rights holder relationships, necessitates the development of new systems and methods for permitting holders of licenses to media, for example, to be able to access as well as listen to and/or view the media across the licensee's many technology platforms in an on-demand manner. Consumers desire easy access to their home media regardless of whether they are home or not. At the same time, media content providers want to prevent unauthorized copying of copyrighted works. The iPod® solution is a portable media player that requires a USB connection and does not allow consumers to access their home media remotely. There remains a need for systems and methods to provide “anywhere” access for consumers while protecting underlying copyrights to desired media.

There also is a need for systems and methods for distributing content as a result of new purchases of rights (e.g., licenses) or as a result of pre-existing rights. In particular, there is a need for systems and methods for facilitating a user's direct access to media at the home across networks by way of any remote device.

In addition, there is a need for systems and methods for using a remote device to purchase content on the home computer and then immediately access and control that media remotely.

Moreover, there is a need for systems and methods for storing media on remote player devices with data storage limitations that otherwise would be exceeded by the file size(s) of the media that a user desires to access, while protecting underlying DRM. One method for storing additional media on these devices is compression. Compression is a way of reducing data size to save storage space or transmission time by minimizing data redundancy. However, even with compression, the number of media files that can be stored in the memory of a remote player device is limited.

Accordingly, there is a need for a reliable and efficient way to transfer data lawfully to a remote player device.

### SUMMARY OF THE INVENTION

In one aspect, the invention relates to systems and methods for turning a home personal computer (PC) with home media into a personal media server that can be directly controlled from any internet or other online remotely connected device. Connections may be facilitated through the use of a third party server (or multiple servers for high demand) to provide connectivity behind Network Address Translation firewalls and to protect DRM. The third party server may be used to merely authenticate the remote device. The third party device may facilitate a direct connection between the remote device and the home PC/server; once authentication has been achieved, the third party device need not participate further in the direct connection.

In some embodiments, the third party server may provide DRM enhancements by allowing for temporary use by a remote device and by monitoring the media being accessed remotely. The encrypted files may not be capable of being used by any other device simultaneously, thereby preventing the ability to copy. The remote device may provide authorization to access media from the home PC while the remote device remains connected (e.g., a permanently connected work PC or a temporarily connected phone).

Yet further, the remote device may be capable of storing encrypted media for disconnected playing for a specified time period or until the remote device reconnects to a third party server to update authorization for accessing/playing the media. Thus, temporarily connected devices (such as cell phones) may be used to play media while being disconnected from the home PC with its home media (e.g., while on an airplane). In some embodiments, a user may easily switch between devices that are connected to the internet or other network but may only authorize one device at a time to play particular media (more than one if permitted, for example, by the owner/licensor of the copyrighted material). While disconnected, the user may listen to media that has been transferred to the remote device. While connected, the home PC, acting as a personal media server, may provide access to a user's entire media library, including playlists.

A system and method of the present invention thus may link a third party server and software on a home computer with a remote device to enable users to remotely access and control home media on different kinds of remote devices while providing temporary DRM to protect owners of copyrighted content.

In one aspect of the invention, an online based server may be used to authenticate a remote device as an authorized device permitted to have access to a personal media server and may facilitate a direct connection from the remote device to the personal media server. Once such a connection is established, data transfer requests may be initiated from the remote device directly to the personal media server. In other words, once authentication has occurred, the online based server is not needed to actually initiate data transfers or transfer communication between the personal media server and the remote device; instead the online based server simply facilitates a secure connection between the personal media server and the remote device.

The invention relates to a method for establishing a two-way direct connection, including: selectively communicating between (1) a remote device and (2) an online based server and a personal media server, the online based server accessible via an address; receiving user input at the remote device to establish the two-way direct connection to receive media associated with the personal media server; sending from the remote device to the online based server a request to contact the personal media server, wherein the request comprises authentication information; authenticating the remote device by the online based server; receiving a response at the remote device to the request from the online based server, the response containing connection information if the remote device is authenticated as having access to the media; directly connecting the remote device to the personal media server using the connection information; and maintaining the two-way direct connection between the remote device and the personal media server without the online based server remaining involved in the two-way direct connection so that data transfer requests associated with the media are initiated from the remote device directly to the personal media server.

In some embodiments, the two-way direct connection may be a two-way wireless connection, and the remote device may be selected from a cellular telephone, personal digital assistant, portable music player, and portable video player. The two-way direct connection may be a telephony connection or an IP connection and the media may include audio and/or video.

The method may further include playing media received from the personal media server with a media player on the remote device.

The media may be digital rights management protected media. Also, the media may include at least one playlist and the method may further include receiving user input at the remote device to modify the playlist on the remote device and/or receiving user input at the remote device to modify the playlist on the personal media server.

The personal media server may be a plurality of independently accessible servers each having the media, the connection information may permit access to the media on each of the independently accessible servers, and the data transfer requests may be initiated from the remote device to any of the independently accessible servers.

The personal media server may have a dynamic IP address. In addition, the connection information may permit access through a Network Address Translation firewall.

In some embodiments of the method, the online based server may restrict access to the media to a single remote device, and the online based server may restrict access to the media for a fixed period of time without the online based server further authenticating the remote device.

The method also may include: receiving user input at the remote device to purchase additional media for initial transfer to the personal media server; and transferring the additional media to the personal media server after the purchase has been authorized by a digital rights management server; wherein the media comprises the additional media. The digital rights management server may be the online based server, and in some embodiments the digital rights management server authorizes transferring the additional media to the personal server from a plurality of third party servers.

In some embodiments, the media may be a media file and data transfer from the personal media server to the remote device may include: receiving one or more fragments of the media file at the remote device, and storing the one or more fragments in a memory having a predetermined size smaller than a data size of the media file; playing the one or more stored fragments on the remote device; receiving additional fragments of the media file at the remote device only after the one or more stored fragments are played; and replacing the one or more stored fragments in the memory with the additional fragments. The media file may have a first data size and the additional fragments may have a second data size, the second data size being smaller than the first data size. Also, the one or more fragments may consist of a subset of the media file.

In some embodiments, the online based server may be an internet based server and the address may be a fixed IP address.

In some embodiments, the method may further include profiling the media and targeting information to the remote device based on the profiling.

The invention further relates to a remote device including a processor and memory storing computer readable instructions that, when executed by the processor, cause the remote device to perform steps of: selectively communicating with an online based server and a personal media server, the online based server accessible via an address; receiving user input to establish a direct connection to receive media associated with the personal media server; sending to the online based server a request to contact the personal media server, wherein the request comprises authentication information; being authenticated by the online based server; receiving a response to the request from the online based server, the response containing connection information if the remote device is authenticated as having access to the media; establishing the direct connection with the personal media server using the connection information; and maintaining the direct connection with the personal media server without the online based server remaining involved in the direct connection so that data transfer requests associated with the media are initiated from the remote device directly to the personal media server. In some embodiments, the processor and memory may be disposed in a cellular telephone.

The invention also relates to a remote device comprising a processor and memory storing computer readable instructions that, when executed by the processor, cause the remote device to perform steps of: establishing a two-way direct connection between a personal media server storing media thereon and the remote device; initiating data transfer requests associated with the media from the remote device directly to the personal media server; and sending the media from the personal media server to the remote device.

In addition, the invention relates to a computer readable medium storing computer readable instructions that, when executed by a processor, cause a remote device to perform steps of: selectively communicating with an online based server and a personal media server, the online based server accessible via an address; receiving user input to establish a two-way direct connection to receive media associated with the personal media server; sending to the online based server a request to contact the personal media server, wherein the request comprises authentication information; being authenticated by the online based server; receiving a response to the request from the online based server, the response containing connection information if the remote device is authenticated as having access to the media; joining the two-way direct connection to the personal media server using the connection information; and maintaining the two-way direct connection with the personal media server without the online based server remaining involved in the two-way direct connection so that data transfer requests associated with the media are initiated from the remote device directly to the personal media server. In some embodiments, the remote device may be a cellular telephone.

Moreover, the invention relates to a system for establishing a two-way direct connection, including: a remote device; an authentication server accessible via an address; a personal media server; a connection between the remote device and the authentication server; and a two-way direct connection between the remote device and the personal media server.

The invention further relates to a method of distributing content from a centralized library including: providing a personal media server with a media library; providing a remote device; providing an online based server accessible via an address; establishing rights to media on the personal media server for access and transfer to the remote device, wherein the remote device requests authentication by the online based server with respect to the rights; transferring media from the media library to the remote device after establishing the rights and without the online based server remaining involved in the transferring. The method may further include purchasing new media via the remote device, wherein the new media is transmitted from a third-party media provider to the personal media server for inclusion in the media library. Also, the method may further include routing the new media from the media library on the personal media server to the remote device; wherein the media comprises the new media.

The online based server may set an expiration date after which content of the media routed to the remote device becomes unplayable by the remote device, and the expiration date may be reset by the online based server when the remote device is connected thereto to set the content to be playable. The online based server may only permit one remote device to have access to the media at any given time, wherein the online based server encrypts the media to restrict transfer thereof from the remote device.

The method may further include providing a purchasing profile on the personal media server; purchasing new media from a third-party media provider via the remote device, wherein the new media is purchased when the online based server accesses the purchasing profile and transmits data therefrom to the third-party media provider. And, the method may include: identifying new media to be acquired from a source thereof; identifying a licensor of the new media via the online based server; purchasing a license to the new media from the licensor via the online based server; transmitting the new media from the source to the personal media server for inclusion in the media library. A plurality of fragments of the media may be routed from the media library on the personal media server to the remote device, the fragments being played sequentially and cached in the remote device to provide an uninterrupted stream of the media.

In another aspect, the invention relates to tools (in the form of methodologies, apparatuses, and systems) for transferring data to a remote player device. The tools may be embodied in one or more computer programs stored on a computer readable medium or program storage device and/or transmitted in the form of a computer data signal in one or more segments via a computer network or other transmission medium.

A method for playing media at a remote player device, according to one example of this disclosure, includes receiving one or more fragments of a media file at the remote player device, and storing the one or more fragments in a memory having a predetermined size smaller than a data size of the media file, playing the one or more stored fragments on the remote player device, allowing additional fragments of the media file to be received by the remote player device, only after the one or more fragments are played, and replacing the one or more fragments in the memory with the additional fragments. In some embodiments, a data size of the additional fragments is smaller than the size of the media file. Also, the one or more fragments may constitute a subset of the media file. And, the remote player device may be selected from the group consisting of a cell phone, personal digital assistant, portable MP3 player, and other remote device. The invention further relates to: a program storage device readable by a computer, tangibly embodying a program of instructions executable by the computer to perform this method; a computer data signal transmitted in one or more segments in a transmission medium which embodies instructions executable by a computer to perform this method; and a computer system including a processor and a program storage device readable by the computer system, tangibly embodying a program of instructions executable by the processor to perform this method.

A method for transferring data from a media download device to a remote player device, according to an example of this disclosure, includes downloading a media file by the media download device, transmitting one or more fragments of the downloaded media file from the media download device to the remote player device, wherein the one or more fragments have a predetermined size smaller than a size of the media file, waiting for the remote player device to play the one or more fragments, and transmitting additional fragments of the media file from the media download device to the remote player device only after the one or more fragments are played by the remote player device. In some embodiments, a data size of the one or more fragments equals or is smaller than a size of a memory of the remote player device. Also, the additional fragments may constitute a subset of the media file. The invention further relates to: a program storage device readable by a computer, tangibly embodying a program of instructions executable by the computer to perform this method; a computer data signal transmitted in one or more segments in a transmission medium which embodies instructions executable by a computer to perform this method; and a computer system including a processor and a program storage device readable by the computer system, tangibly embodying a program of instructions executable by the processor to perform this method.

A media transfer system, according to one example of this disclosure includes a media download device including communication means for receiving a media file from a media source, storage means for storing the received media file, a communication controller, and transmitting means for transmitting one or more fragments of the stored media file, selectively retrieved from the storage means under control of the communication controller, wherein the one or more fragments have a predetermined size smaller than a size of the media file, a remote player device including receiving means for receiving the one or more fragments from the transmitting means of the media download device; and storing the one or more fragments in a memory having a predetermined size smaller than a data size of the media file, and a player controller, wherein the player controller controls operation of the remote player device, causes the one or more stored fragments in the memory to be played on the remote player device, and after the one or more stored fragments are played, controls the receiving means to receive additional fragments of the media file from the media download device.

A media transfer system, according to another example of this disclosure includes a server and a client, wherein the client receives one or more fragments of a media file from the server, stores the one or more received fragments in memory, and plays the stored fragments before receiving additional fragments of the media file from the server, and the server transmits the additional fragments of the media file only after the client has played the stored fragments. In some embodiments, the stored fragments played by the client may constitute a subset of the media file. Also, a size of the memory may be smaller than a size of the media file. And, a fragment size of the additional fragments may be greater than a difference between a data size of the one or more fragments and a size of the memory.

### BRIEF DESCRIPTION OF THE DRAWINGS

Preferred features of the present invention are disclosed in the accompanying drawings, wherein:

FIG. 1 shows a block diagram of an exemplary computer system capable of implementing the method and system of the present disclosure;

FIG. 2A shows a block diagram illustrating a system for transferring data to a remote player device, according an embodiment of the present disclosure;

FIG. 2B shows a flow chart illustrating a method for transferring data to a remote player device, according to an embodiment of the present disclosure;

FIG. 2C shows a flow chart illustrating a method for transferring data to a remote player device, according to an embodiment of the present disclosure;

FIG. 3 shows a block diagram describing the relationship between a server, a client and a connection broker, according to an example of the present disclosure;

FIG. 4 shows a block diagram describing the relationship between a server, a client and a connection broker, according to another example of the present disclosure;

FIG. 5 shows a flow diagram describing a data flow of the system of FIG. 3, according to one example;

FIG. 6 shows a block diagram illustrating division of the data/music file into sequential frames, according to an example of the present disclosure;

FIG. 7 shows a block diagram illustrating division of the data/music file into sequential frames, according to another example of the present disclosure;

FIG. 8 shows a flow diagram describing the data flow of the system of FIG. 3, according to another example;

FIG. 9 shows a block diagram illustrating message transmission techniques for transferring data to a remote player device, according to an example of the present disclosure;

FIG. 10 shows a flow chart illustrating details of processing by the connection broker shown in FIG. 3;

FIG. 11 shows a flow chart illustrating details of processing by the server shown in FIG. 3;

FIG. 12 shows another block diagram illustrating a system for transferring data to a remote player device, according an embodiment of the present invention;

FIG. 13 shows an exemplary authentication sequence in which a remote device requests authentication from an online based server for the purpose of accessing a personal media server; and

FIG. 14 shows an exemplary sequence of steps in which a remote device establishes communication with a personal media server after authentication and plays media from the personal media server.

### DETAILED DESCRIPTION OF THE PREFERRED EMBODIMENTS

The following exemplary embodiments are set forth to aid in an understanding of the subject matter of this disclosure, but are not intended, and may not be construed, to limit in any way the claims which follow thereafter. Therefore, while specific terminology is employed for the sake of clarity in describing some exemplary embodiments, the present disclosure is not intended to be limited to the specific terminology so selected, and it is to be understood that each specific element includes all technical equivalents which operate in a similar manner.

In one aspect, the present disclosure relates to the implementation of an exemplary transfer methodology for the transmission of data files, such as media files (e.g., MP3 files). While it is recognized that “MP3” refers to a particular audio encoding scheme, as used herein, the term “MP3” is used to refer to digital music files in general, and may include digital music using other encoding or compression algorithms. Moreover, it should be understood that while reference is made herein to digital music for exemplary purposes, it should be understood that the concepts of the present disclosure can be applied to video and other digital media as well.

More specifically, in one aspect the present disclosure relates to the sequential transfer of data in sizes manageable by small remote player devices, such as PDAs, cellular telephones, or portable MP3 players. The techniques of the present disclosure are designed for incremental, sequential file transfer which is capable of passing small portions of a file to a remote device, using that file portion, passing a subsequent file portion to a remote device, and deleting the file portion after it has been used. Further, where the file is to be passed across the Internet, the present disclosure provides means for remotely controlling the distribution of a copyrighted file.

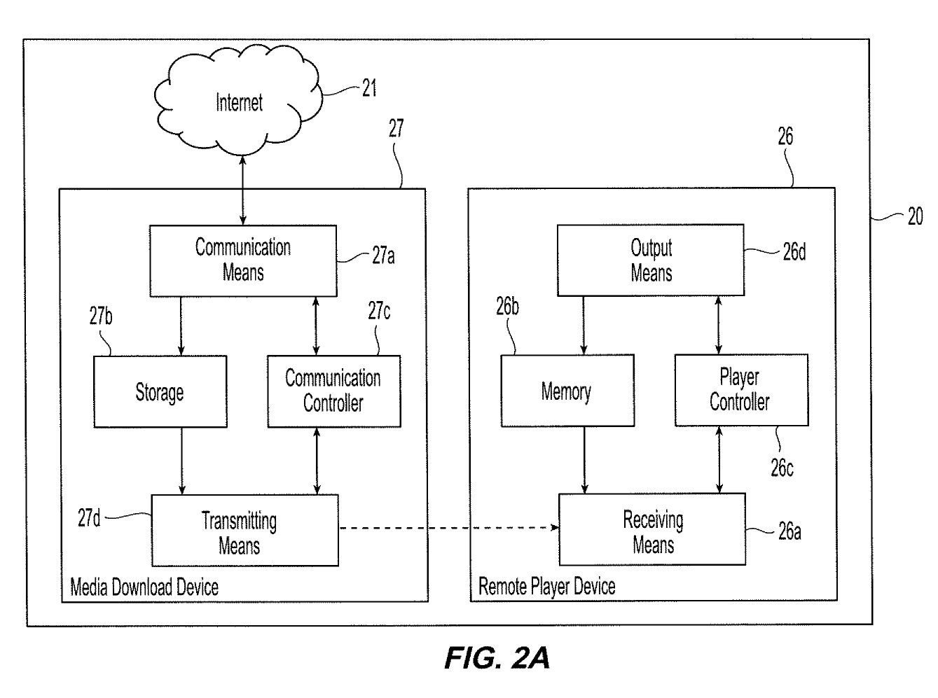

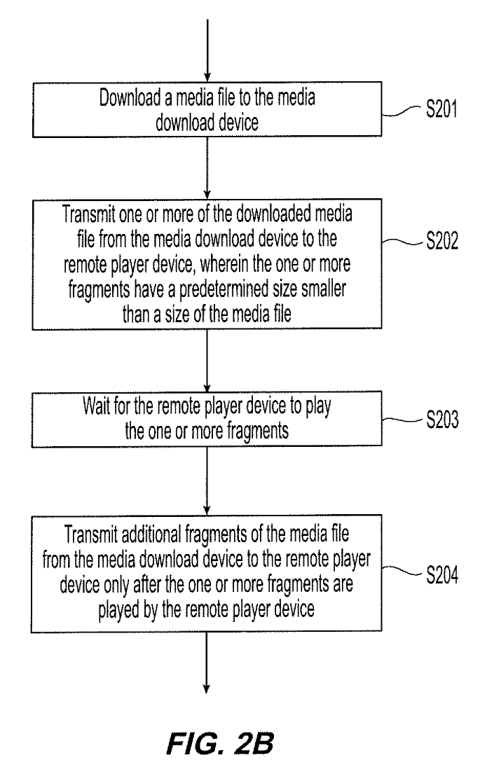

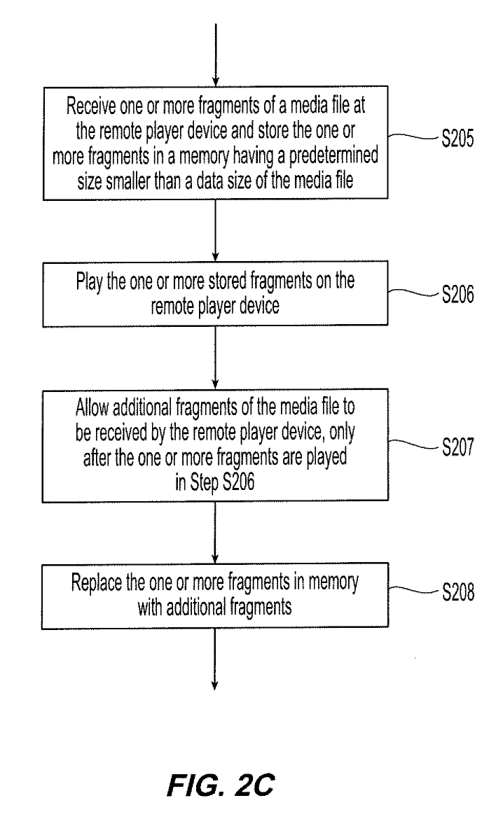

A system for transferring data to a remote player device, according to one embodiment of the disclosure, will be discussed with reference to FIG. 2A. The system 20 includes a media download device 27, including communication means 27a, storage means 27b, communication controller 27c and transmitting means 27d, and a remote player device 26 including receiving means 26a, memory 26b, player controller 26c and output means 26d. The media download device 27 receives a media file from a media source through communication means 27a and stores the received media file in the storage 27b. The transmitting means 27d transmits one or more fragments of the stored media file, selectively retrieved from the storage means 27b under control of the communication controller 27c. The one or more fragments have a predetermined size smaller than the size of the media file. The remote player device 26 includes receiving means 26a for receiving the one or more fragments from the transmitting means 27d of the media download device, and storing the one or more fragments in a memory 26b having a predetermined size smaller than the data size of the media file. The player controller 26c controls the operation of the remote player device 26 and causes one or more stored fragments in the memory 26b to be played on the remote player device 26. After the one or more stored fragments are played, the player controller 26c controls the receiving means 26a to receive additional fragments of the media file from the media download device 27.

The systems and methods of the present disclosure may be implemented in the form of a software application running on a computer system, for example, a personal computer (PC), handheld computer, client-server system, or another computing system, etc. The software application may be stored on or in a storage medium locally accessible by the computer system, for example, floppy disk, optical disc, hard disk, etc., or may be remote from the computer system and accessible via a wired or wireless connection to a network, for example, a local area network, or the Internet.

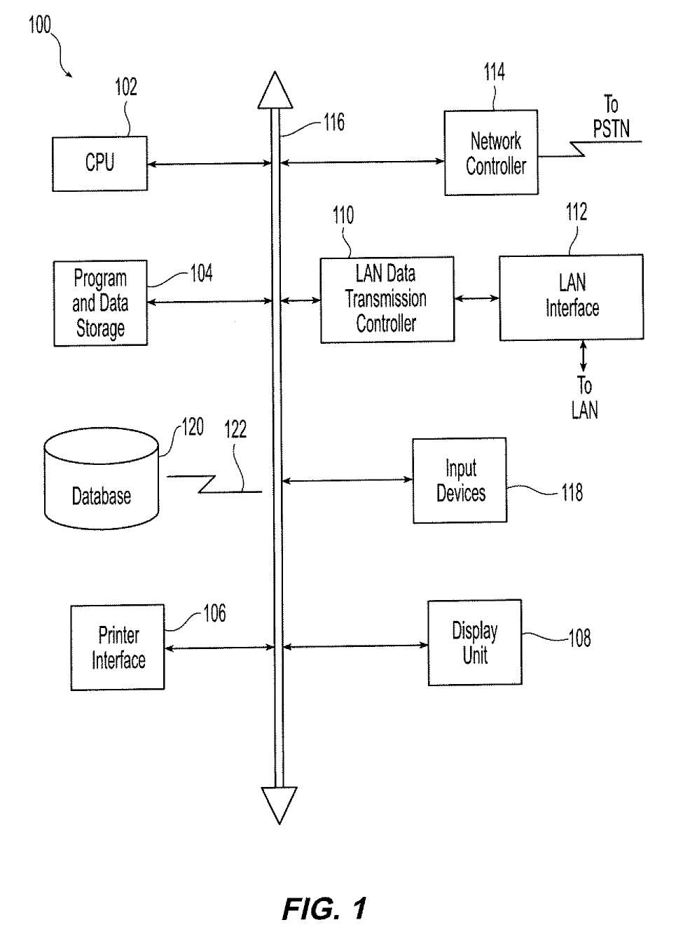

FIG. 1 shows an example of a computer system 100 which may implement a media download device. The computer system 100 can include a central processing unit (CPU) 102, program and data storage devices 104, a printer interface 106, a display unit 108, a (LAN) local area network data transmission controller 110, a LAN interface 112, a network controller 114, an internal bus 116, and one or more input devices 118 (for example, a keyboard, mouse etc.). As shown, the system 100 may be connected to a database 120, via a link 122.

The computer system 100 is merely exemplary. The specific embodiments described herein are illustrative. Computer system(s) as referred to herein may include(s) individual computers, servers, computing resources, networks, etc. Many variations can be introduced on these embodiments without departing from the spirit of the disclosure or from the scope of the appended claims.

A method for transferring data from a media download device to a remote player device, according to an embodiment of the present disclosure, will be explained with reference to FIGS. 2A and 2B. The communication means 26a downloads a media file to the media download device 27. (Step S201). The transmitting means 27d transmits one or more fragments of the downloaded media file from the media download device 27 to the remote player device 26 wherein the one or more fragments have a predetermined size smaller than a size of the media file (Step S202). The media download device 27 waits for the remote player device 26 to play the one or more fragments (Step S203) and then it transmits additional fragments of the media file to the remote player device 26 only after the one or more fragments are played by the remote player device (Step S204).

A method for playing media at a remote player device, according to an embodiment of the present disclosure, will be explained below with reference to FIGS. 2A and 2C. The receiving means 26a receives one or more fragments of a media file at the remote player device 26, and stores the one or more fragments in a memory 26b having a predetermined size smaller than a data size of the media file (Step 8205). The player controller 26c plays the one or more stored fragments on the remote player device through the output means 26d (Step S206). The player controller 26c also allows additional fragments of the media file to be received by the remote player device, only after the one or more fragments are played in Step S206 (Step S207) and replaces the one or more fragments in the memory with the additional fragments (Step S208).

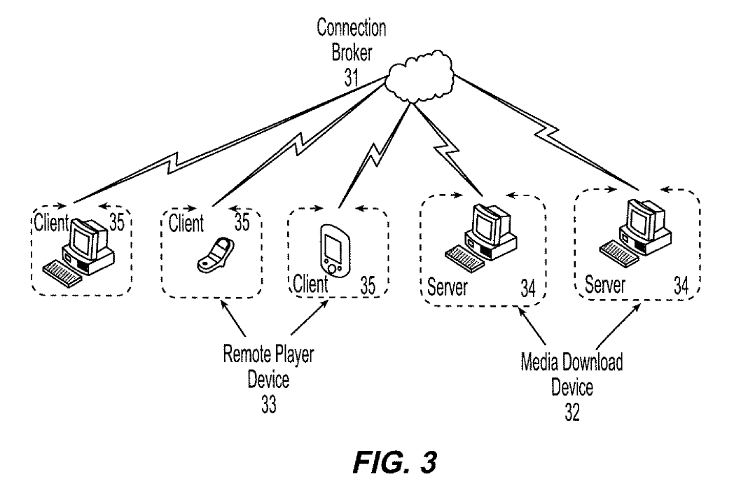

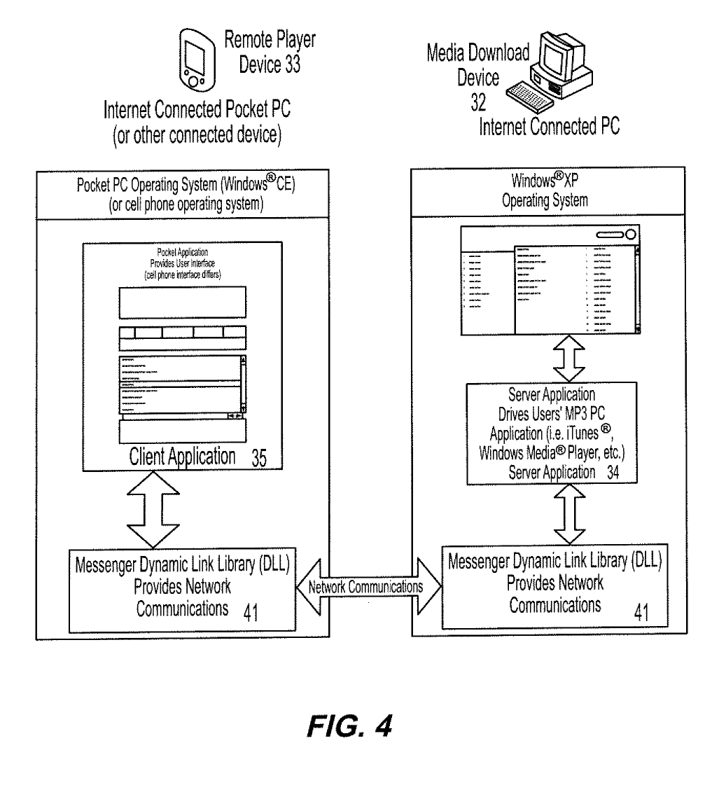

FIGS. 3 and 4 are a block diagrams describing the relationship between a server, a client and a connection broker, according to an example of the present disclosure. There may be three hardware components to this system: (1) a connection broker 31; (2) a media download device 32; and (3) a remote player device 33. The connection broker 31 may be a server located on the Internet and may be used to manage user login subscription information and/or validation information and may also be used to broker a connection between the media download device 32 and the remote player device 33. The media download device 32 may be a home-based desktop computer or any other storage system with an internet connection and is capable of running the server 34. The server 34 may run on the operating system of the media download device 32. The media download device 32 may serve as the file repository for the files to be managed, such as, for example, the music files. The remote player device 33 may be a PDA, cellular telephone, PC, or any device which is capable of running the client 35. The client 35 may run on the operating system of the remote player device 33.

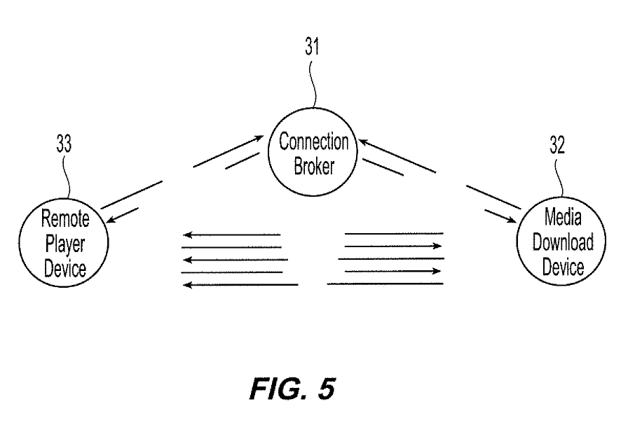

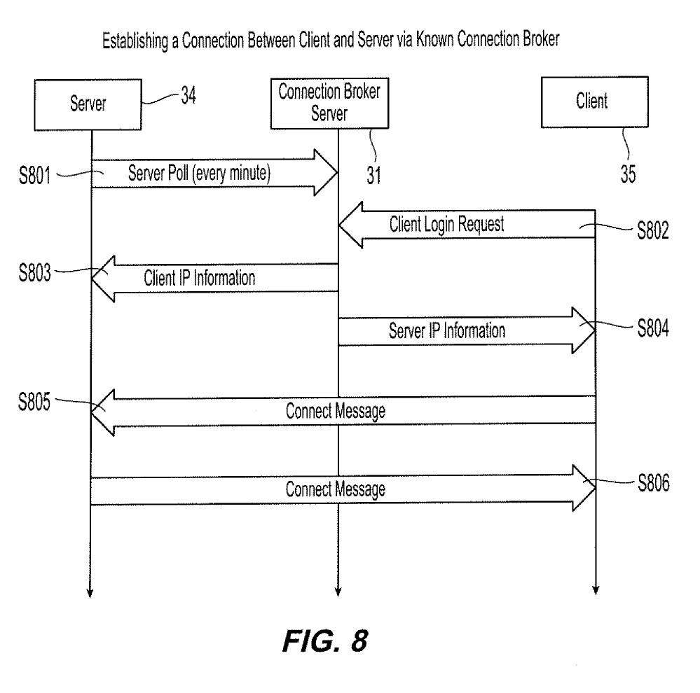

FIGS. 5 and 8 show flow diagrams describing the data flow of the system of FIG. 3. The server polls the connection broker at predetermined intervals, for example, one minute (Step S801). If the client 35 requests login (Step S802), the connection broker passes the client IP information to the server 34 and the server IP information to the client 35 (Step S803 & S804). Once the connection broker 31 passes the connection details to both the server 34 of the media download device 32 and the client 35 of the remote player device 33, the media download device 32 and the remote player device 33 can communicate directly with each other through the messenger dynamic link library 41 without further intervention on the part of the connection broker 31 (Step S805 & S806).

The media download device 32 can pass to the remote player device 33 a list of files that are available to the remote player device 33. These files are presented to the user through the client 35. Once the user selects a file, this information is passed to the server 34 running on the media download device 32.

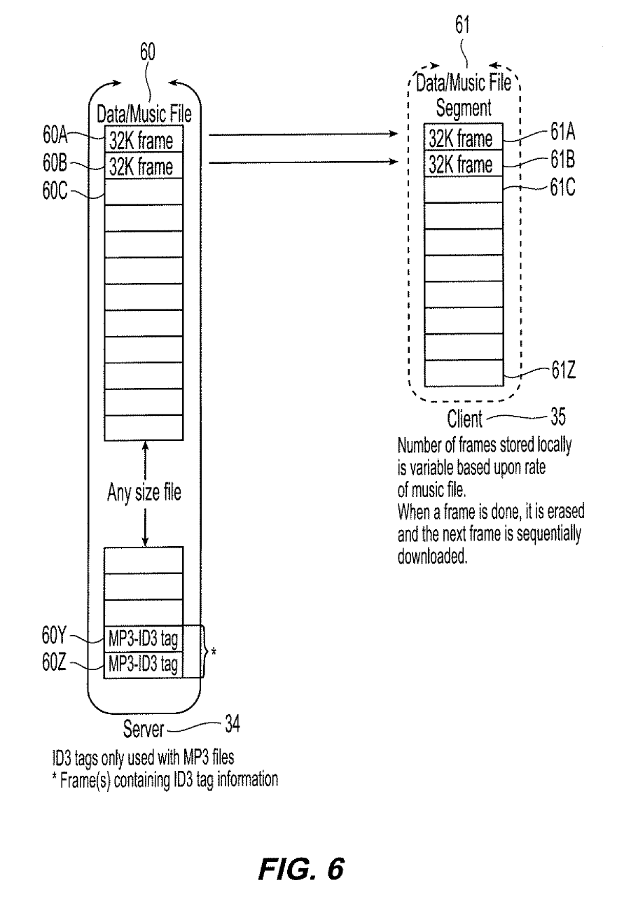

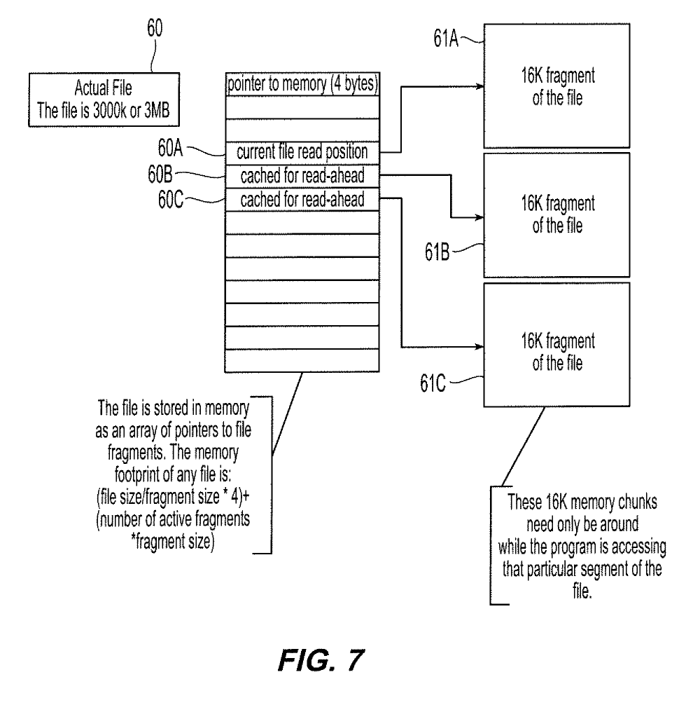

According to an example of the present disclosure, the server 34 divides the data/music file 60 into sequential frames, as illustrated in FIGS. 6 and 7. In the case of an MP3 audio file format, one or more ID3 tag frames 60Y, 60Z may be appended to the end of the frame buffer. The server 34 may pass a number of frames 60A, 60B, 60C . . . 60Z of a data/music file 60 in sequential order to the remote player device 33 as they are requested by the remote player device 33. The number of frames passed 61 is variable and dependent upon the media requirements and the capacity of the remote player device. As a frame is played 61A, it is erased from the remote player device 33 and the next sequential frame 62A is passed from the media download device 32 to the client 35 of the remote player device 33. This process continues until the end of the file is reached 61Z. The number of frames may be based on the size of the media, not the capacity of remote player device 33. However, the number of frames that are stored in memory on remote player device 33 at any one time may be dependent on the memory capacity of remote player device 33. Thus, in one embodiment, this explains why a “cleanup” process is used to free frames on remote player device 33 that have already been used by the media player. According to an embodiment of the present disclosure, the user may queue any number of files into a playlist for continuous transfer of those files in the order displayed in a user interface on the client.

Thus, to summarize, “thin file access” provides a method of sequential file access that allows for a significant reduction in memory footprint. A file is divided into fragments, each of which is referenced by a pointer to memory. As the file is read, only that section of the file that is currently being accessed is loaded into memory. For multi-media files, one or two fragments are read in to prevent skipping. The functions fopen, fseek, fclose, and fread are standard C functions which are replaced using the thin file access method. When an application calls an fread( ) function, the thin file access software will return data from internal fragments loaded in memory or request those fragments before returning data. This method is functional locally or over a network, the latter being the primary use. A client on the network requests fragments as the client application requires them. The fragments are packaged up at the server and delivered to the client for storage in local memory. The client software when reading file data is actually reading data from the local cache of file fragments.

The remote player device 33 may display a console and/or slider bar or other graphical indicator (such as a clock-like icon with a hand that moves around the circle) that for example may indicate the location of the pointer with respect to the length of data/music file 60. A user may use graphical buttons on the console to start, stop, play, pause, reverse and fast forward the media, and the user may also drag a control on the slider bar to reverse and fast forward the media by changing the location of the pointer. Further, the user may move the pointer to skip to any portion of the media, such as a song. In effect, by changing the location of the control indicator along the slider bar, a user may send a command to home server 34 to set the pointer to a particular frame and from that frame begin passing frames of data/music file 60 to remote player device 33. Essentially, remote PVR capabilities may be provided in this manner.

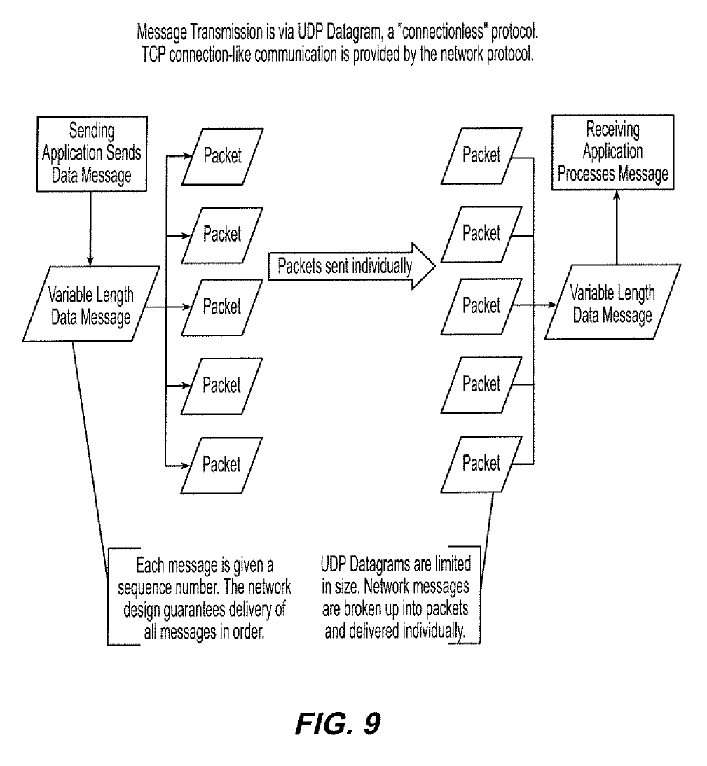

FIG. 9 shows a block diagram illustrating message transmission techniques for transferring data to a remote player device, according to an example of the present disclosure. In particular, message transmission is via User Datagram Protocol (UDP) Datagram, a “connectionless” protocol. Transmission Control Protocol (TCP) connection-like communication may be provided by network protocol. In this embodiment, a sending application sends a data message. A variable length data message is divided into packets which are individually sent, received as a variable length data message, and processed as a message by the receiving application. Because UDP datagrams are limited in size, network messages are broken up into packets and delivered individually. During sending, each message is given a sequence number, and the network design may guarantee delivery of all messages in order.

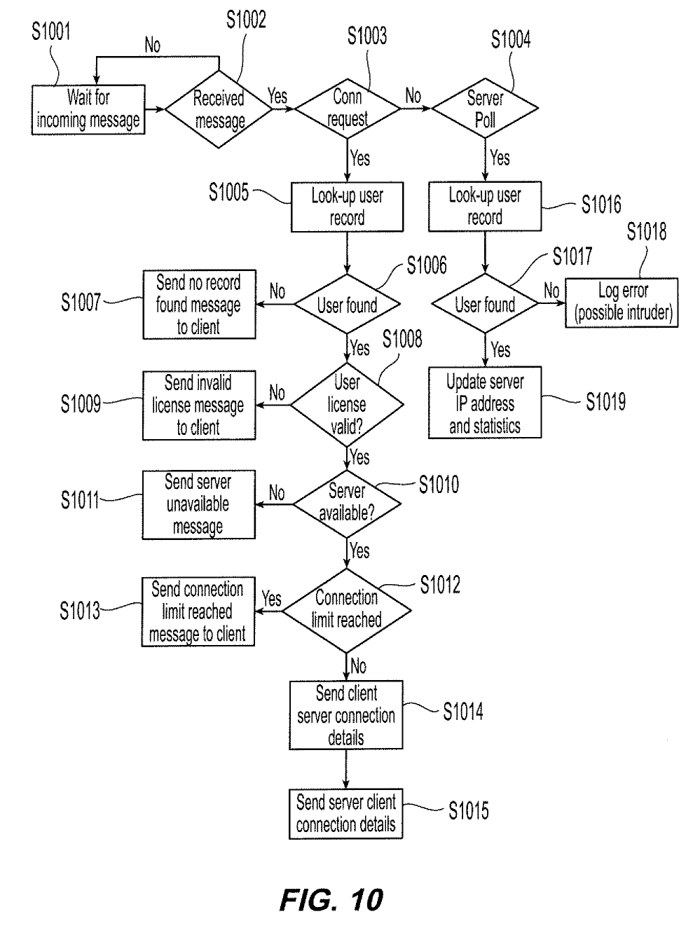

FIG. 10 shows a flow chart illustrating details of the connection broker 31 shown in FIG. 3. The connection broker 31 waits for an incoming message (Step S1001). If an incoming message is received (Yes, Step S1002), then the connection broker 31 checks to see if the incoming message is a connection request (Step S1003). If the incoming message is a connection request, then the connection broker 31 looks up the user record (Step S1005). If the user is not found (No, Step S1006), then a message is sent to the client that no user was located (Step S1007). However, if the user is found (Yes, Step S1006), the connection broker 31 checks to see if the user license is valid (Step S1008). If the user license is not valid (No, Step S1008), then a message is sent to the client that the license is invalid (Step S1009). However, if the user license is valid (Yes, Step S1008), then the connection broker 31 checks to see if the server is available (Step S1010). If the server is not available (No, Step S1008), then a message is sent to the client indicating that the server is unavailable (Step S1011). However, if the server is available (Yes, Step S1010), then the connection broker 31 checks to see if the connection limit is reached (Step S1012). If the connection limit is reached (Yes, Step S1012), then a message is sent to the client indicating that the connection limit has been reached (Step S1013). However, if the connection limit is not reached (No, Step S1012), then the server connection details are sent to the client (Step S1014) and the client connection details are sent to the server (Step S1015). If the incoming message is not a connection request (No, Step S1003), the connection broker checks to see if it is a server poll (Step S1004). If the incoming message is a server poll (Yes, Step S1004), the connection broker 31 looks up the user record (Step S1016). If the user is found (Yes, Step S1017), then the server P address and statistics are updated (Step S1019). If the user is not found (No, Step S1017), then the connection broker 31 issues a login error (Step S1018).

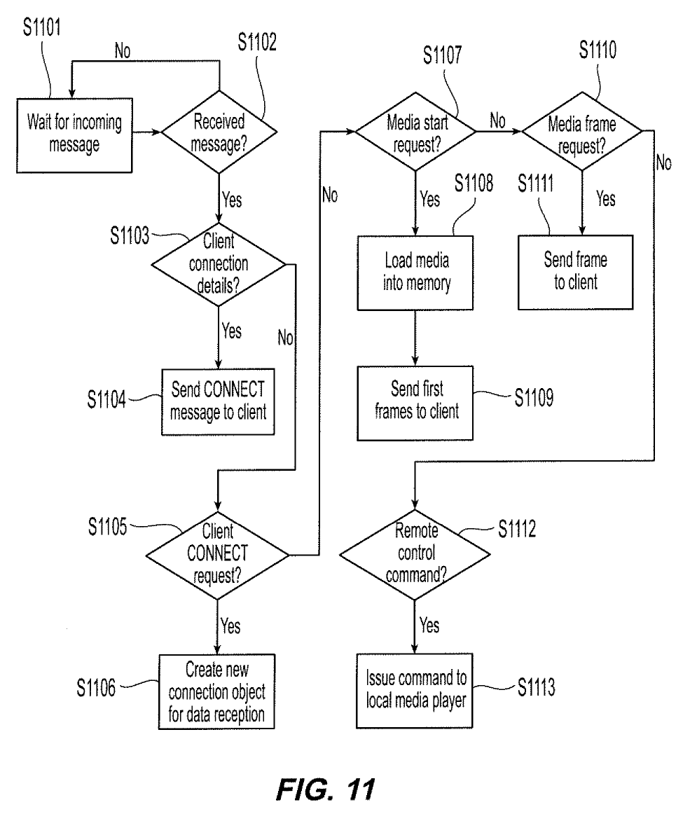

FIG. 11 shows a flow chart illustrating details of the server 34 of a media download device 32 shown in FIG. 3. The server 34 waits for an incoming message (Step S1101). If an incoming message is received (Yes, Step S1102), then the server 34 checks to see if the incoming message contains client connection details (Step S1103). If the message contains client connection details (Yes, Step S1103), then the server 34 sends a “connect message” to the client 35. However, if the incoming message does not contain the client connection details (No, Step S1103), then the server 34 checks to see if the incoming message is a connection request (Step S1105). If the incoming message is a client request (Yes, Step S1105), the server 34 creates a new connection object for data reception (Step S1106). However, if the incoming message is not a client request (No, Step S1105), then the server 34 checks to see if the request is a media start request (Step S1107). If the incoming message is a media start request (Yes, Step S1107), then the server 34 loads the media into memory (Step S1108) and sends the first three frames and last frame to the client 35 of the remote player device 33 (Step S1109). If the incoming message is not a media start request (No, Step S1107), then the server 34 checks to see if the incoming message is a media frame request (Step S1110). If the incoming message is a media frame request (Yes, Step S1110), the server 34 sends the frame to the client 35 of the remote player device 33 (Step S1111). However, if the incoming message is not a media frame request (No, Step S1110), then the server 34 checks to see if the incoming message is a remote control command (Step S1112). If the incoming message is a remote control command (Yes, Step S1112), then the server 34 issues the command to the local media player (Step 81113).

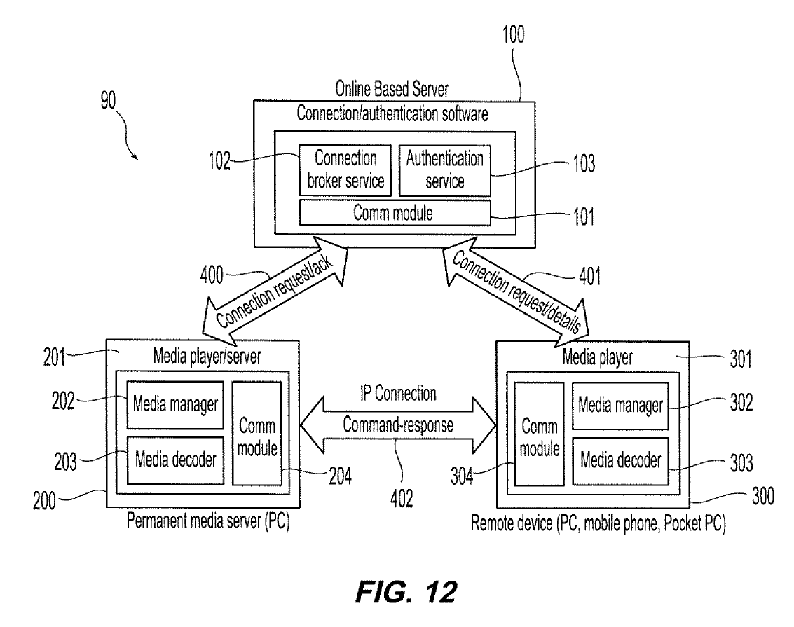

Turning to FIG. 12, another aspect of the present invention related systems and methods for accessing media will be described. As shown in FIG. 12, an exemplary embodiment a system 90 includes an Online Based Server 100 that for example may be a server personal computer (PC) that is connected to the internet or other online network and is accessible via a real Internet Protocol (IP) address. Thus, in an exemplary embodiment, Online Based Server 100 may be an internet based server, although in other embodiments Online Based Server 100 for example may be part of an intranet, a cable television head-end system, public cellular telephony network (PCTN), or part of an operations center for a direct broadcast satellite (DBS) system. In addition, a Personal Media Server 200 is provided and may be a PC that, for example, typically resides within a person's home. Personal Media Server 200 also could be a cable or satellite set top box, a Personal Video Recorder (PVR), wireless device, or some other computing device in the home or combination of any of the above operably in communication with one another. The Personal Media Server 200 includes one or more processors connected to a communications bus. The computer system 200 also includes a main memory. Main memory may be random access memory (RAM), read only memory (ROM), EPROM, and/or EEPROM. The Personal Media Server 200 further includes secondary memory. Secondary memory includes, for example, one or more hard disk drives and/or removable storage drives. A removable storage drive could be, for example, a floppy disk drive, a magnetic tape drive, a compact disk drive, a program cartridge and cartridge interface, or a removable memory chip.

Personal Media Server 200 may be connected to the internet via broadband connection (e.g., DSL, cable, fiber, satellite, wireless, or other means) and has typical disk storage capacity that contains media owned by or licensed to the owner of the PC.

A Remote Device 300 also is provided and for example may be a PC, mobile phone, iPOD® like device, web-based digital tablet, PDA, wireless device, mobile device, or pocket PC that has sufficient features to allow it to be a multimedia player having features such as stereo output, typical display capabilities, simple input keys and/or a touch screen, and/or microphone and voice recognition unit, and also may be connected to the internet or other online network for example by wireless fidelity (WiFi) or other wireless access scheme, the telephony network, and/or a wired connection.

In an exemplary preferred embodiment, the media associated with system 90 is music, audio/video, or video in a digital form with or without DRM features applied. Exemplary formats of audio media for use with the present invention include, but are not limited to, MP3, Windows Media® Audio (WMA), WMA with DRM 9, and linear PCM WAV. Exemplary formats of video media for use with the present invention include, but are not limited to, AVI, DivX®, XviD4, MPEG-1, MPEG-2, MPEG4-SP, Windows Media® Video (WMV) 9, and Motion-JPEG. In some embodiments, graphics file media in formats such as TFF, GF, JPEG, and PICT also may be associated with system 90. For example, while Remote Device 300 plays a song, graphics showing pictures of the band or lyrics can be displayed on the device display.

In the exemplary embodiment, Online Based Server 100 includes connection/authentication software providing a communications module 101, a connection broker service 102, and an authentication service 103.

Media Player/Server 201 may be software running on Personal Media Server 200 that may be capable of: (1) managing the location of media files on local storage devices associated with Personal Media Server 200, (2) downloading media files from a third party media provider via the internet or other network, (3) accepting connection requests from remote devices, (4) responding to commands from such remote devices, and (5) playing media on Personal Media Server 200.

Media Player 301 may be software running on Remote Device 300 that is capable of: (1) connecting to the Media Player/Server 201 on the Personal Media Server 200 from anywhere on the internet or other network, (2) issuing commands to Media Player/Server 201, (3) processing responses from Media Player/Server 201, (4) managing local media content, and (5) playing media on Remote Device 300.

As shown in FIG. 12, an IP connection 402 may be established between Personal Media Server 200 and Remote Device 300. A connection 400 may be established between Online Based Server 100 and Personal Media Server 200, while a connection 401 may be established between Online Based Server 100 and Remote Device 300.

As part of the remote control system, exemplary commands issued from Remote Device 300 to Personal Media Server 200 include the following.

Send Media Library: request a media library from Personal Media Server 200, the media library for example including playlists of audio (e.g., songs) and/or video.

Play Media Remotely: request a currently selected media file (audio or video file) to be played on Remote Device 300.

Play Song Local: request a selected song from a playlist to be played on Personal Media Server 200 or home stereo if connected to Personal Media Server 200 for example by cable, WiFi, or the internet and not on Remote Device 300. This permits music, for example, to be played from Personal Media Server 200 so that it either plays on Remote Device 300 or it actually plays on Personal Media Server 200 to be routed around the house to different locations like stereos.

Send Song Artwork: request Personal Media Server 200 to send artwork for a song that is currently being played.

Search My Media Library Remotely: request Personal Media Server 200 to send back a list of media that have met search criteria sent from Remote Device 300.

Edit Media Library Remotely: request Personal Media Server 200 to update a media library with changes made to the media library playlists from Remote Device 300.

Find Song Media From Store Remotely: request Personal Media Server 200 to send back a list of songs that can be purchased and that have met song search criteria.

Purchase Song Media Remotely: request Personal Media Server 200 to purchase a song on behalf of Remote Device 300, and once Personal Media Server 200 has purchased the song, have the song immediately ready so that Remote Device 300 can play it.

Preferably, Media Player/Server 201 and Media Player 301 further provide users with standard features typical of media players such as shuffle, playlists, tag searching, etc.

In an exemplary embodiment, Online Based Server 100 is used to authenticate Remote Device 300 as an authorized device permitted to have access to Personal Media Server 200 and may facilitate a two-way direct connection from Remote Device 300 to Personal Media Server 200. If the user's credentials are not authenticated, access is denied. Once such a connection is established, data transfer requests may be initiated from Remote Device 300 directly to Personal Media Server 200. In other words, once authentication has occurred, Online Based Server 100 is not needed to actually initiate data transfers between Personal Media Server 200 and Remote Device 300; instead Online Based Server 100 simply facilitates a secure connection between Personal Media Server 200 and Remote Device 300. As used herein, the term “two-way direct connection” means a connection not made through Online Based Server 100 but otherwise the connection is not limited to passing through the system of the internet, routers, or other networks to link Personal Media Server 200 and Remote Device 300.

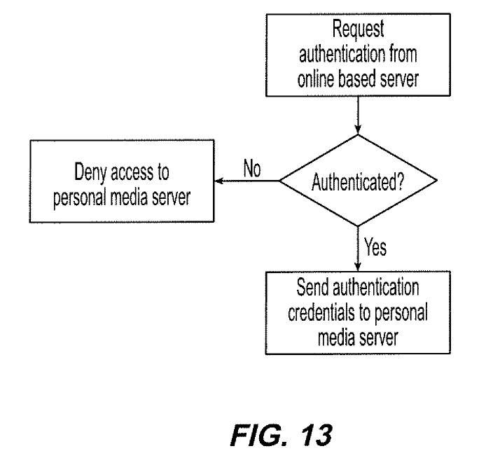

Authentication protocols may be conventional, as readily known in the art. For example, when Remote Device 300 is authenticated as being permitted to have access to Personal Media Sever 200, Online Based Server for example may send data to one or both of Remote Device 300 and Personal Media Sever 200 to permit initiation of communication between these devices. Such data for example may be credentials that permit Remote Device 300 to recognize Personal Media Sever 200. An exemplary authentication sequence is shown in FIG. 13.

Thus, Online Based Server 100, the third party server (exchange broker), may not act like a “policeman” to protect DRM. It may be assumed that if media is present on Personal Media Server 200 it is rightfully present on server 200. The copyright, however, may be protected in two primary ways: (i) by authenticating the user and a specific device belonging to the user to avoid for example sharing passwords or “broadcasting” to many people at once, and (ii) by sending the data in a way that it can't be copied remotely and in fact is not copied even by the remote device (although in some embodiments temporary copies may be made with media that allows this). This is particularly useful in situations in which a content provider has zero copy DRM. If a user, for example, had a movie stored on their home PC, they could access that movie anywhere without making a copy and the user would also not be able to make a copy for someone else.

Advantageously, Remote Device 300 may be permitted to directly control Personal Media Server 200 through an IP connection 402 therebetween. In addition, because Remote Device 300 is provided with an integral media player 301, there is no need to wait for a media player to launch on receipt by Remote Device 300 of a media file from Personal Media Server 200. Moreover, system 100 ensures that a user has sufficient rights to media on Personal Media Server 200 and prevents any degrading of any DRM on media files because those files can only be accessed by authorized devices/users and cannot be copied from Remote Device 300. With IP connection 402, Remote Device 300 also may permit remote modification of playlists on Personal Media Server 200. Playlists locally stored on Remote Device 300 also may be modified by a user and the modified playlists may be transmitted to Personal Media Server 200.

In operation according to an exemplary embodiment, the Remote Device 300 initiates a connection by sending a connection request to Online Based Server 100. This is done because of the dynamic IP addressing associated with Network Address Translation (NAT) firewall-style protection. Personal Media Server 200 regularly polls Online Based Server 100 (e.g., once per minute) because of the dynamic IP address. In order to permit connections through the firewall protection—so-called “punch holes”—firewall rules allow only a particular connection to be made through the firewall. In some embodiments, Online Based Server 100 limits the number of connections to Personal Media Server 200. In any event, the connection process is completed so that the connection is established between Personal Media Server 200 and an authorized Remote Device 300. In one preferred exemplary embodiment, communications modules 101, 204, and 304 of Online Based Server 100, Personal Media Server 200, and Remote Device 300, respectively, are all the same or similar and use the same protocol. In particular, communications modules 101, 204, and 304 may be socket-based, IP message delivery and receiving modules.

Media managers 202, 302 of Personal Media Server 200 and Remote Device 300, respectively, provide a custom database of available media thereon. Media managers 202, 302 provide lists of every available media file and globally unique identifiers may be assigned to each media file.

Finally, media decoders 203, 303 of Personal Media Server 200 and Remote Device 300, respectively, may be conventional media decoders such as the FMOD sound system (Firelight Technologies Pty, Ltd.). The conventional media decoder provides a cross platform audio library and toolset which, for example, supports Windows CE (Pocket PC/Smart phone) and Linux platforms as well as supports a wide range of audio file formats such as those listed elsewhere herein.

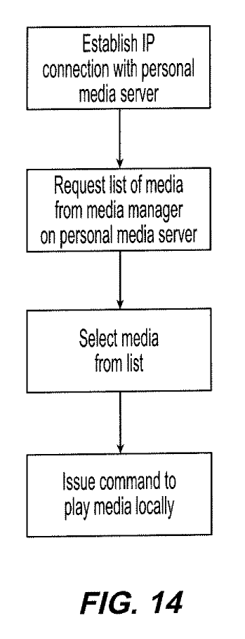

Once the Remote Device 300 is connected to Personal Media Server 200 over connection 402, information may be exchanged to determine differences in the media files available on each device, e.g., which media files are not yet available on Remote Device 300. The determination, for example, may be made by software on Remote Device 300. Information to be exchanged may include titles, indexes, playlists, and other identifiers for the media files. A Remote Device 300 user may select a media file from a playlist (such as by using a touch point device, a scroll wheel, or voice recognition) and issue a command such as Play Media Remotely to be executed, for example, for media not locally available on Remote Device 300. An exemplary sequence of steps is shown in FIG. 14. The “thin file access” capabilities as described elsewhere herein may be provided on Remote Device 300 so that the media file may be read into a buffer and broken into fragments. Depending on the format of the media (MPEG, etc.), certain fragments may need to be sent to Remote Device 300 initially because of the information contained in those fragments. For example, the initial fragment sent to Remote Device 300 may include the first and last frames of a file along with three frames following the first frame (frames 0, N, and 1-3) because some media includes tags for file size, name of media, artist, track, year, and other information in the first and last frames. Media Player 301 may then request further sequences of fragments to play additional or remaining portions of the requested media. Fragments may be requested as a function of network availability and memory. Fragments may continue to be requested by Media Player 301 and delivered from Personal Media Server 200 until all frames of the media file have been delivered Error correction also may be employed.

Alternatively, upon command from the Remote Device 300, the Personal Media Server 200 could repetitively transmit frames 1 to N in the form of a “carousel.” When it is time to load the next y number of frames into the buffer, the mobile player can identify and decode those frames from the continuous transmission. Once the song, for example, is played, Remote Device 300 may send a command to terminate the transmission. This aspect of the invention also would allow other remote devices to effectively download and play the same songs broadcast from Personal Media Server 200.

Advantageously, fragments may be delivered from multiple sources assuming that each of the sources makes the same media available in a properly licensed form. For example, for a media file of fifty frames, frames 1-9 and 50 (collectively, fragment 1) might be delivered from a first source, frames 10-19 (collectively, fragment 2) from a second source, frames 20-29 (collectively, fragment 3) from a third source, frames 30-39 (collectively, fragment 4) from a fourth source, and frames 40-49 (collectively, fragment 5) from a fifth source. If sufficient buffer space is available on Remote Device 300, these five fragments may be delivered simultaneously so that transmission latency problems (e.g., on a cellular phone network) are avoided thus permitting the media to be played without any perceptible interruption.

Alternatively, a user may utilize a feature to only make use of Media Player 301 on Remote Device 300 to access locally stored media.

In addition, a user may utilize the Play Song Local feature as a remote control feature. This allows Remote Device 300 to command Personal Media Server 200 to play a song on the player of Personal Media Server 200 (not the player of Remote Device 300).

Any of a variety of data communications protocols may be used with the present invention such as TCP/IP, wireless, Voice Over IP (VoIP), and others.

In yet another aspect of the present invention, media may be purchased via commands issued from Remote Device 300 while having the purchased media remotely downloaded onto Personal Media Server 200 from anywhere the purchased media is available on the internet. The purchased media then may be accessed immediately by the purchaser using the authenticated connection between Remote Device 300 and Personal Media Server 200. Because the user/purchaser is actually purchasing the media via Personal Media Server 200, which may for example include a purchasing profile thereon with account and/or credit card information, there is no need for a separate account to be created on, or credit card information to be provided directly by Remote Device 300 for use in the transaction. In some embodiments, purchasing of media from a third-party media provider via the remote device occurs when Online Based Server 100 accesses the purchasing profile on Personal Media Server 200 and transmits data therefrom to the third-party media provider.

In a further aspect of the present invention, a consumer may download media directly from any of a plurality of rights holders in that media after paying the appropriate license fee to the content provider (rights holder/broker), thereby obviating the need for intermediary content providers, potentially speeding download times, and protecting DRM through Online Based Server 100. For example, if a user desires to purchase rights to media and download it to Personal Media Server 200, the media may be available from multiple sources who rightfully have obtained the media. If ten individuals each have a media library accessible and/or searchable via the internet, Online Based Server 100 may facilitate the identification of each of those sources of the media associated with the rights acquired by the consumer. The media may be downloaded to Personal Media Server 200 from any of those sources. Still further, should access by Remote Device 300 to media associated with media rights possessed by a consumer be more expedient from one of those ten alternate sources rather than from Personal Media Server 200 (due to data transmission speeds, intermittent connection outages, etc.), Remote Device 300 may be permitted to access one or more of the alternate sources to obtain the media. Thus, in some embodiments, peer-to-peer communication is permitted between Remote Device 300 and multiple home servers, for example, where the same media exists across multiple users' machines, with the result that faster remote playing may be achieved.

In another aspect of the present invention, Online Based Server 100 or any other site may include profiling and targeting software. The information collected and stored in a database may include the name, telephone number, email address, IP address, SMS device and address of, or naming convention for, a person or business. The information also may relate to such demographics as household income, buying habits, gender, music tastes, video tastes, ethnicity, education level, and personal interests, for example. The information may be obtained by accessing other databases, queries and responses from a user, or from monitoring the online habits of the user. In this manner, targeted advertising may be forwarded to the user on any device based on profile characteristics. For example, if the user enjoys rock music, the user may receive email or other messages highlighting certain new rock songs. From a link in the message, the user via Remote Device 300 may command the download of one or more songs to the user's Personal Media Server 200. Information from multiple users may be aggregated and packaged according to any of the aforementioned categories.

While various descriptions of the present invention are described above, it should be understood that the various features can be used singly or in any combination thereof. Therefore, this invention is not to be limited to only the specifically preferred embodiments depicted herein.

Further, it should be understood that variations and modifications within the spirit and scope of the invention may occur to those skilled in the art to which the invention pertains. Accordingly, all expedient modifications readily attainable by one versed in the art from the disclosure set forth herein that are within the scope and spirit of the present invention are to be included as further embodiments of the present invention. The scope of the present invention is accordingly defined as set forth in the appended claims.

What is claimed is:

1. A method for establishing a two-way direct connection, comprising:
selectively communicating between (1) a remote device and (2) an online based server and a personal media server, the online based server accessible via an address;
receiving user input at the remote device to establish the two-way direct connection to receive media associated with the personal media server;
sending from the remote device to the online based server a request to contact the personal media server, wherein the request comprises authentication information;
authenticating the remote device by the online based server;
receiving a response at the remote device to the request from the online based server, the response containing connection information if the remote device is authenticated as having access to the media;
directly connecting the remote device to the personal media server using the connection information; and
maintaining the two-way direct connection between the remote device and the personal media server without the online based server remaining involved in the two-way direct connection so that data transfer requests associated with the media are initiated from the remote device directly to the personal media server.

2. The method of claim 1, wherein the two-way direct connection comprises a two-way wireless connection.

3. The method of claim 1, wherein the remote device is selected from the group consisting of a cellular telephone, personal digital assistant, portable music player, and portable video player.

4. The method of claim 1, wherein the two-way direct connection comprises a telephony connection.

5. The method of claim 1, wherein the media comprises audio.

6. The method of claim 1, wherein the media comprises video.

7. The method of claim 1, wherein the two way connection is an IP connection.

8. The method of claim 1, further comprising:
playing media received from the personal media server with a media player on the remote device.

9. The method of claim 1, wherein the media comprises digital rights management protected media.

10. The method of claim 1, wherein the media comprises at least one playlist.

11. The method of claim 10, further comprising:
receiving user input at the remote device to modify the playlist on the remote device.

12. The method of claim 10, further comprising:
receiving user input at the remote device to modify the playlist on the personal media server.

13. The method of claim 1, wherein the personal media server comprises a plurality of independently accessible servers each having the media.

14. The method of claim 13, wherein:
the connection information permits access to the media on each of the independently accessible servers; and
the data transfer requests are initiated from the remote device to any of the independently accessible servers.

15. The method of claim 1, wherein the personal media server has a dynamic IP address.

16. The method of claim 1, wherein the connection information permits access through a Network Address Translation firewall.

17. The method of claim 1, further comprising:
the online based server restricting access to the media to a single remote device.

18. The method of claim 17, further comprising:
the online based server restricting access to the media for a fixed period of time without the online based server further authenticating the remote device.

19. The method of claim 1, further comprising:
receiving user input at the remote device to purchase additional media for initial transfer to the personal media server; and
transferring the additional media to the personal media server after the purchase has been authorized by a digital rights management server;
wherein the media comprises the additional media.

20. The method of claim 19, wherein the digital rights management server is the online based server.

21. The method of claim 19, wherein the digital rights management server authorizes transferring the additional media to the personal server from a plurality of third party servers.

22. The method of claim 1, wherein the media comprises a media file and data transfer from the personal media server to the remote device comprises:
receiving one or more fragments of the media file at the remote device, and storing the one or more fragments in a memory having a predetermined size smaller than a data size of the media file;
playing the one or more stored fragments on the remote device;
receiving additional fragments of the media file at the remote device only after the one or more stored fragments are played; and
replacing the one or more stored fragments in the memory with the additional fragments.

23. The method of claim 22, wherein the media file has a first data size and the additional fragments have a second data size, the second data size being smaller than the first data size.

24. The method of claim 22, wherein the one or more fragments consist of a subset of the media file.

25. The method of claim 1, wherein the online based server is an internet based server.

26. The method of claim 1, further comprising:
profiling the media.

27. The method of claim 26, further comprising:
targeting information to the remote device based on the profiling.

28. The method of claim 1, wherein the address is a fixed IP address.

29. A remote device comprising a processor and memory storing computer readable instructions that, when executed by the processor, cause the remote device to perform steps of:
selectively communicating with an online based server and a personal media server, the online based server accessible via an address;
receiving user input to establish a direct connection to receive media associated with the personal media server;
sending to the online based server a request to contact the personal media server, wherein the request comprises authentication information;
being authenticated by the online based server;
receiving a response to the request from the online based server, the response containing connection information if the remote device is authenticated as having access to the media;
establishing the direct connection with the personal media server using the connection information; and
maintaining the direct connection with the personal media server without the online based server remaining involved in the direct connection so that data transfer requests associated with the media are initiated from the remote device directly to the personal media server.

30. The remote device of claim 29, wherein the processor and memory are disposed in a cellular telephone.

31. A remote device comprising a processor and memory storing computer readable instructions that, when executed by the processor, cause the remote device to perform steps of:
establishing a two-way direct connection between a personal media server storing media thereon and the remote device;
initiating data transfer requests associated with the media from the remote device directly to the personal media server; and
sending the media from the personal media server to the remote device.

32. A computer readable medium storing computer readable instructions that, when executed by a processor, cause a remote device to perform steps of:
selectively communicating with an online based server and a personal media server, the online based server accessible via an address;
receiving user input to establish a two-way direct connection to receive media associated with the personal media server;
sending to the online based server a request to contact the personal media server, wherein the request comprises authentication information;
being authenticated by the online based server;
receiving a response to the request from the online based server, the response containing connection information if the remote device is authenticated as having access to the media;
joining the two-way direct connection to the personal media server using the connection information; and
maintaining the two-way direct connection with the personal media server without the online based server remaining involved in the two-way direct connection so that data transfer requests associated with the media are initiated from the remote device directly to the personal media server.

33. The computer readable medium of claim 32, wherein the remote device is a cellular telephone.

34. A system for establishing a two-way direct connection, comprising:
a remote device;
an authentication server accessible via an address;
a personal media server;
a connection between the remote device and the authentication server;
a two-way direct connection between the remote device and the personal media server.

35. A method of distributing content from a centralized library comprising:
providing a personal media server with a media library;
providing a remote device;
providing an online based server accessible via an address;
establishing rights to media on the personal media server for access and transfer to the remote device, wherein the remote device requests authentication by the online based server with respect to the rights;
transferring media from the media library to the remote device after establishing the rights and without the online based server remaining involved in the transferring.

36. The method of claim 35, further comprising:
purchasing new media via the remote device, wherein the new media is transmitted from a third-party media provider to the personal media server for inclusion in the media library.

37. The method of claim 35, further comprising:
routing the new media from the media library on the personal media server to the remote device;
wherein the media comprises the new media.

38. The method of claim 35, wherein the online based server sets an expiration date after which content of the media routed to the remote device becomes unplayable by the remote device.

39. The method of claim 38, wherein the expiration date is reset by the online based server when the remote device is connected thereto to set the content to be playable.

40. The method of claim 35, wherein the online based server only permits one remote device to have access to the media at any given time.

41. The method of claim 40, wherein the online based server encrypts the media to restrict transfer thereof from the remote device.

42. The method of claim 35, further comprising:
providing a purchasing profile on the personal media server;
purchasing new media from a third-party media provider via the remote device, wherein the new media is purchased when the online based server accesses the purchasing profile and transmits data therefrom to the third-party media provider.

43. The method of claim 35, further comprising:
identifying new media to be acquired from a source thereof;
identifying a licensor of the new media via the online based server;
purchasing a license to the new media from the licensor via the online based server;
transmitting the new media from the source to the personal media server for inclusion in the media library.

44. The method of claim 35, wherein a plurality of fragments of the media are routed from the media library on the personal media server to the remote device, the fragments being played sequentially and cached in the remote device to provide an uninterrupted stream of the media.

45. A method for playing media at a remote player device, comprising:
(a) receiving one or more fragments of a media file at the remote player device, and storing the one or more fragments in a memory having a predetermined size smaller than a data size of the media file;
(b) playing the one or more stored fragments on the remote player device;
(c) allowing additional fragments of the media file to be received by the remote player device, only after the one or more fragments are played in (b); and
(d) replacing the one or more fragments in the memory with the additional fragments.

46. The method of claim 45, wherein a data size of the additional fragments is smaller than the size of the media file.

47. The method of claim 45, wherein the one or more fragments constitute a subset of the media file.

48. The method of claim 45, wherein the remote player device is selected from the group consisting of a cell phone, personal digital assistant, portable MP3 player, and other remote device.

49. A method for transferring data from a media download device to a remote player device, comprising:
(a) downloading a media file by the media download device;
(b) transmitting one or more fragments of the downloaded media file from the media download device to the remote player device, wherein the one or more fragments have a predetermined size smaller than a size of the media file;
(c) waiting for the remote player device to play the one or more fragments; and
(d) transmitting additional fragments of the media file from the media download device to the remote player device only after the one or more fragments are played by the remote player device.

50. The method of claim 49, wherein a data size of the one or more fragments equals or is smaller than a size of a memory of the remote player device.

51. The method of claim 49, wherein the additional fragments constitute a subset of the media file.

52. A program storage device readable by a computer, tangibly embodying a program of instructions executable by the computer to perform the method of claim 45.

53. A program storage device readable by a computer, tangibly embodying a program of instructions executable by the computer to perform the method of claim 49.

54. A computer data signal transmitted in one or more segments in a transmission medium which embodies instructions executable by a computer to perform the method of claim 45.

55. A computer data signal transmitted in one or more segments in a transmission medium which embodies instructions executable by a computer to perform the method of claim 49.

56. A computer system comprising:
a processor; and
a program storage device readable by the computer system, tangibly embodying a program of instructions executable by the processor to perform the method of claim 45.

57. A computer system comprising:
a processor; and
a program storage device readable by the computer system, tangibly embodying a program of instructions executable by the processor to perform the method of claim 49.

58. A media transfer system, comprising:
a media download device including communication means for receiving a media file from a media source, storage means for storing the received media file, a communication controller, and transmitting means for transmitting one or more fragments of the stored media file, selectively retrieved from the storage means under control of the communication controller, wherein the one or more fragments have a predetermined size smaller than a size of the media file;
a remote player device including receiving means for receiving the one or more fragments from the transmitting means of the media download device; and storing the one or more fragments in a memory having a predetermined size smaller than a data size of the media file; and
a player controller, wherein the player controller controls operation of the remote player device, causes the one or more stored fragments in the memory to be played on the remote player device, and after the one or more stored fragments are played, controls the receiving means to receive additional fragments of the media file from the media download device.

59. A media transfer system comprising a server and a client, wherein the client receives one or more fragments of a media file from the server, stores the one or more received fragments in memory, and plays the stored fragments before receiving additional fragments of the media file from the server, and the server transmits the additional fragments of the media file only after the client has played the stored fragments.

60. The media transfer system of claim 59, wherein the stored fragments played by the client constitute a subset of the media file.

61. The media transfer system of claim 59, wherein a size of the memory is smaller than a size of the media file.

62. The media transfer system of claim 59, wherein a fragment size of the additional fragments is greater than a difference between a data size of the one or more fragments and a size of the memory.
